(19) United States
(12) Patent Application Publication
(10) Pub. No.: US 2009/0091642 A1
(43) Pub. Date: Apr. 9, 2009

(54) Image defect correction system using directional detection

(75) Inventors: Ikumi Minema, Yokohama (JP); Nobuyoshi Tanaka, Yokohama (JP); Masaru Sakai, Yokohama (JP)

Correspondence Address: Joe McKinney Muncy, PO Box 1364, Fairfax, VA, 22038-1364, US

(73) Assignee: Winbond Electronics Corp.

(21) Appl. No.: 11/905,689

(22) Filed: Oct. 3, 2007

(51) Int. Cl. H04N 9/64

(52) U.S. Cl. 348/246; 348/E09.037

(57) ABSTRACT

An image defect correction system using directional detection. An image data memory stores a two-dimensional image data output from an image capturing device. A decision means decides whether a target pix cell is a defective pix cell by deciding whether an image data of the target pix cell is a prominent spot using a plurality of image data of the target pix cell and 8 adjacent pix cells arranged in 4 directions of upper-lower, left-right, lower-right and upper-right, counting direction number having the prominent spot, and deciding whether the target pix cell is the defective pix cell according to the counted direction number. A replacement means replaces the image data of the target pix cell with a predetermined image data when the target pix cell is determined to be the defective pix cell.

### BACKGROUND OF THE INVENTION

1. Field of the Invention

The invention relates to an image defect correction system, and more particularly to an image defect correction system using directional detection.

2. Description of the Related Art

In an image capturing system (e.g. digital still camera and video camcoder), a solid state image capturing device has been widely used, for example charge coupled device (CCD) imager or complementary metal oxide semiconductor (CMOS) imager. In the solid state image capturing device, some crystal defects exist. The crystal defects are composed of intrinsic defects in silicon wafer material and extrinsic defects caused by subsequent wafer processing. The crystal defects appear as image defects, such as white defects being brighter than surrounding areas and black defects being darker than surrounding areas. The image defects significantly deteriorate an image quality.

Various methods are provided to correct the image defects. A method for electronically correcting the defective image is provided. The method comprises steps: to calculate an average level, a maximum level and a minimum level by using image data of 8 peripheral pix cells adjacent to a target pix cell; to generate a decision measure for white defects by adding a difference between the maximum level and the minimum level to the average level; to generate a decision measure for black defects by subtracting the difference between the maximum level and the minimum level from the average level; to decide whether the target pix cell is a defective pix cell by comparing the image data of the target pix cell with the decision measures; and to replace the image data of the target pix cell with a predetermined level (e.g. an average level of the image data of 8 peripheral pix cells) when the target pix cell is decided to be the defective pix cell.

In the above method, however, the detection accuracy of the white or black defects is not good due to detection by averaging. In addition, the method may miscount an edge portion of the image as the defective pix cell.

### BRIEF SUMMARY OF THE INVENTION

For the aforementioned reasons, the invention provides an image defect correction system using directional detection in order to mitigate the problems in the prior art.

The invention discloses an image defect correction system using directional detection comprising an image data memory for storing a two-dimensional image data output from an image capturing device, a decision means for deciding whether a target pix cell is a defective pix cell by deciding whether an image data of the target pix cell is a prominent spot by using a plurality of image data of the target pix cell and 8 adjacent pix cells arranged in 4 directions of upper-lower, left-right, lower-right and upper-right, counting direction number having the prominent spot, and deciding whether the target pix cell is the defective pix cell according to the counted direction number, and a replacement means for replacing the image data of the target pix cell with a predetermined image data when the target pix cell is determined to be the defective pix cell.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of an image defect correction system using directional detection according to the invention;

FIG. 2 is a pix cell arrangement to illustrate a directional detection method according to the invention;

FIG. 3 is a method for calculating a white prominent rate and a white smoothness rate;

FIG. 4 is a method for calculating a black prominent rate and a black smoothness rate; and

FIG. 5 is a pix cell arrangement to illustrate the directional defect detection method when successive 2 defective pix cells exist in a left-right direction.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

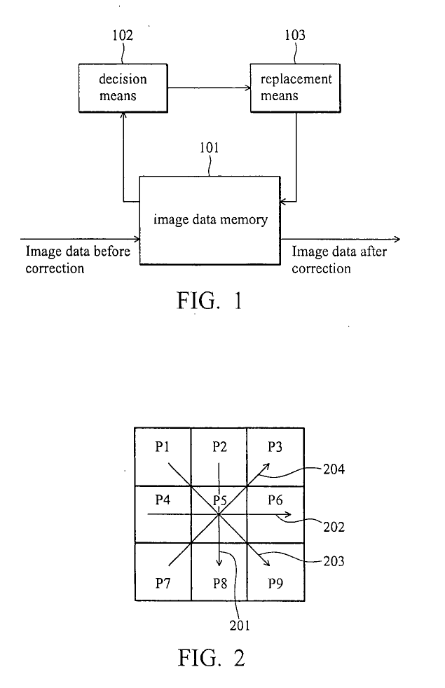

FIG. 1 is a block diagram of an image defect correction system using directional detection according to the invention. The system comprises an image data memory 101 for storing a two-dimensional image data, a decision means 102 for deciding whether a target pix cell is a defective pix cell and a replacement means 103 for replacing an image data of the target cell with a predetermined image data. The system is operated as follows. An analog image signal from an image capturing device (not shown, such as CCD imager or CMOS imager) is converted to a digital image data by an A/D converter (not shown). The digital image data is clamped by a clamping circuit (not shown) and corrected by a lens aberration correction circuit (not shown). The clamped and corrected image data is applied to the image data memory 101, wherein an image data of one frame is stored in the image data memory 101. The image data of one frame is sequentially read from the image data memory 101 and input to the decision means 102 in order to decide whether the target pix cell is the defective pix cell. If the target pix cell is decided to be the defective pix cell by the decision means 102, an image data of the target pix cell is replaced with the predetermined image data by the replacement means 103. The image data with the corrected image defect is then input to an image data processor, converted to a predetermined data format and recorded in a recording media.

FIG. 2 is a pix cell arrangement to illustrate a directional detection method according to the invention. There are 8 adjacent pix cells P1-P4, P6-P9 around the target pix cell P5. First, a left-right direction 202 using pix cells P4, P5 and P6 is considered.

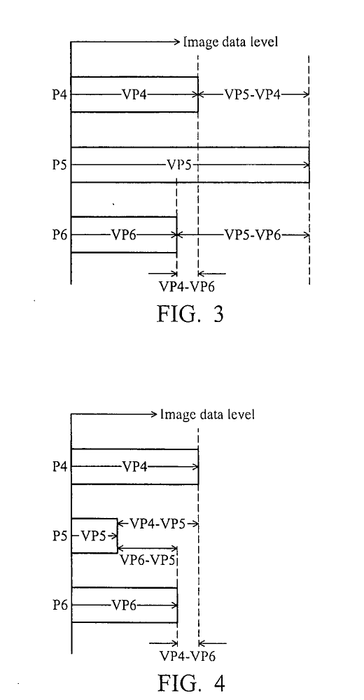

FIG. 3 is a method for calculating a white prominent rate and a white smoothness rate. First, the white prominent rate between image data VP5 of the target pix cell P5 and image data VP4 and VP6 of adjacent pix cells P4 and P6 is calculated and compared with a predetermined value Th1, which is a constant value larger than noise level and is experimentally and empirically decided.

VP5−VP4>Th1 (1)

VP5−VP6>Th1 (2)

Then, the white smoothness rate between 2 adjacent pix cells P4 and P6 is calculated and compared with a predetermined value Th2, which is a constant value larger than noise level and is experimentally and empirically decided.

|VP4−VP6|<Th2 (3)

When formulas (1), (2) and (3) are concurrently satisfied, the target pix cell P5 is decided to be the white prominent spot in the left-right direction 202.

FIG. 4 is a method for calculating a black prominent rate and a black smoothness rate. First, the black prominent rate between image data VP5 of the target pix cell P5 and image data VP4 and VP6 of adjacent pix cells P4 and P6 is calculated and compared with a predetermined value Th3, wherein the predetermined value Th3 is a constant value smaller than noise level and is experimentally and empirically decided.

VP4−VP5>Th3 (4)

VP6−VP5>Th3 (5)

Then, the black smoothness rate between 2 adjacent pix cells P4 and P6 is calculated and compared with a predetermined value Th4, wherein the predetermined value Th4 is a constant value smaller than noise level and is experimentally and empirically decided.

|VP4−VP6|<Th4 (6)

When formulas (4), (5) and (6) are concurrently satisfied, the target pix cell P5 is decided to be the black prominent spot in the left-right direction 202.

Next, similar calculations and conditional decisions in the other 3 directions of upper-lower 201, upper-right 203 and lower-right 204 are also performed. If the conditional decisions are satisfied in the 4 directions, the target pix cell P5 is determined to be the defective pix cell.

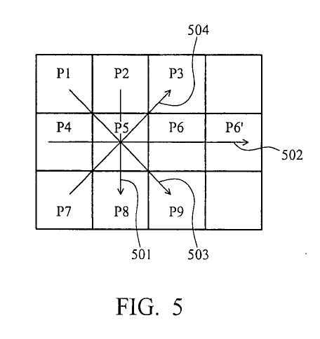

FIG. 5 is a pix cell arrangement to illustrate the directional defect detection method when successive 2 defective pix cells exist in a left-right direction. If formulas (1) (2) and (3), or (4), (5) and (6) are satisfied only in the 3 directions, the target pix cell P5 may be a part of successive defective cells. In this case, an additional step similar to FIG. 3 and FIG. 4 is added to decide whether the image data of the target pix cell P5 is a prominent spot by using a next adjacent pix cell P6′ instead of the adjacent pix cell P6. If formulas (1), (2) and (3), or (4), (5) and (6) are satisfied in a left-right direction 502, the target pix cell P5 is determined to be a part of successive defective cells. The successive defective pix cells of more than 2 may be detected by using a similar method.

The replacement means 103 has three replacement methods. A first replacement method is disclosed, wherein the image data of the defective pix cell is replaced by an average value of the direction having a minimum difference among the image data of the 4 adjacent pix cells. The average value is calculated according to the following directions:

| | |
|---|---|
| \|VP8-VP2\| | upper-lower direction; |
| \|VP6-VP4\| | left-right direction; |
| \|VP3-VP7\| | lower-right direction; and |
| \|VP9-VP1\| | upper-right direction |

, and a minimum value in the above 4 values is selected to replace the image data. This method can result in an image having a high resolution.

A second replacement method is disclosed, wherein the image data of the defective pix cell is replaced by an average value of the direction having a minimum difference between the image data of the target pix cell and the adjacent pix cells. The average value is calculated according to the following directions:

| | |
|---|---|
| \|VP5-VP2\| + \|VP5-VP8\| | upper-lower direction; |
| \|VP5-VP4\| + \|VP5-VP6\| | left-right direction; |
| \|VP5-VP7\| + \|VP5-VP3\| | lower-right direction; and |
| \|VP5-VP1\| + \|VP5-VP9\| | upper-right direction, |

and a minimum value in the above 4 values is selected to replace the image data.

A third replacement method is disclosed, wherein the image data of the defective pix cell is replaced by an average value of the inage data VP2, VP4, VP6 and VP8 of 4 adjacent pix cells.

In contrast to the conventional method, the image defect correction system using directional detection and the method disclosed in the invention have improved detection accuracy to detect defective pix cells, and can replace the image data of the defective pix cell with the most accurate image data.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image defect correction system using directional detection, comprising:
an image data memory for storing a two-dimensional image data output from an image capturing device;
a decision means for deciding whether a target pix cell is a defective pix cell by
deciding whether an image data of the target pix cell is a prominent spot by using a plurality of image data of the target pix cell and 8 adjacent pix cells arranged in 4 directions of upper-lower, left-right, lower-right and upper-right,
counting direction number having the prominent spot, and
deciding whether the target pix cell is the defective pix cell according to the counted direction number; and
a replacement means for replacing the image data of the target pix cell with a predetermined image data when the target pix cell is determined to be the defective pix cell.

2. The system as claimed in claim 1, wherein deciding whether the image data of the target pix cell is the prominent spot comprises:
calculating level differences of image data between the target pix cell and the adjacent pix cells; and
deciding the image data of the target pix cell is the prominent spot when the calculated level difference of image data between the target pix cell and the adjacent pix cell is larger than a first predetermined value and the calculated level difference of image data between one adjacent pix cell and the other adjacent pix cell is smaller than a second predetermined value.

3. The system as claimed in claim 1, wherein the target pix cell is determined to be the defective pix cell when the counted direction number is 4.

4. The system as claimed in claim 2, wherein the target pix cell is determined to be the defective pix cell when the counted direction number is 4.

5. The system as claimed in claim 1, wherein an extra step is added to decide whether the image data of the target pix cell is the prominent spot by using the image data of the target pix cell and a next adjacent pix cell instead of the adjacent pix cell in the direction without the prominent spot when the counted direction number is 3, and the target pix cell is determined to be a part of successive defective pix cells when the target pix cell is the prominent spot.

6. The system as claimed in claim 2, wherein an extra step is added to decide whether the image data of the target pix cell is the prominent spot by using the image data of the target pix cell and a next adjacent pix cell instead of the adjacent pix cell in the direction without the prominent spot when the counted direction number is 3, and the target pix cell is determined to be a part of successive defective pix cells when the target pix cell is the prominent spot.

7. The system as claimed in claim 1, wherein the predetermined image data is an average value of the direction having a minimum difference among the image data of the 4 adjacent pix cells.

8. The system as claimed in claim 1, wherein the predetermined image data is an average value of the direction having a minimum difference between the image data of the target pix cell and the adjacent pix cells.

9. The system as claimed in claim 1, wherein the predetermined image data is an average value of the image data of the 4 adjacent pix cells.
